(19) United States
(12) Patent Application Publication
(10) Pub. No.: US 2002/0037019 A1
(43) Pub. Date: Mar. 28, 2002

(54) Transport module for SDH/SONET

(75) Inventor: Volkmar Heuer, Ditzingen (DE)

Correspondence Address: SUGHRUE MION ZINN MACPEAK & SEAS, PLLC, 2100 Pennsylvania Avenue, NW, Washington, DC, 20037-3213, US

(73) Assignee: ALCATEL

(21) Appl. No.: 09/961,285

(22) Filed: Sep. 25, 2001

(30) Foreign Application Priority Data
Sep. 26, 2000 (DE) 100 47 510.8

(51) Int. Cl. H04J 3/02

(52) U.S. Cl. 370/539; 370/541

(57) ABSTRACT

A method is proposed for transmitting virtual containers of SDH or SONET signals in which a group of AU-3s or AU-4s or AU-3-Nc's or AU-4-4c's is transmitted in a novel VC-Y-Xc transport module having an AU-PTR and an AU-POH for the group. The VC-Y-Xc transport module for SDH or SONET serves to form a group of virtual containers and has a PTR for the group, a POH for the group and a maximum of X-1 virtual container locations for transmitting tributary bits, where X is a natural number greater than 1 and Y is equal to 3 or 4 or a natural number greater than 1. For higher-order transmission channels, for example, VC-4s or VC-3s or also VC-4-Nc's or VC-3-3Nc's, a channel bundling is performed if said channels are transported jointly at least over a subsection. The network management has only to manage, to protect and to switch the one bundle instead of a multiplicity of individual channels.

### TECHNICAL FIELD

The invention relates to a transport module for SDH/SONET. The inventions is based on a priority application DE 100 47 510.8 which is hereby incorporated by reference.

### BACKGROUND OF THE INVENTION

In SDH networks and SONET networks, the scope of the network management correlates tasks with the number of channels transmitted simultaneously (SDH=synchronous digital hierarchy and SONET=synchronous optical network). The more channels that are transmitted, the more tasks have to be carried out. The tasks include, for example, configuration, administration, maintenance and supervision. Owing to the ever-increasing requirement for data transmission, the available number of transmission channels in the backbone network increases continuously. This results, in turn, in an increased requirement for so-called line equipment and network management. Line equipment includes, for example, ADMs and CCs (ADM=add drop multiplexer and CC=cross-connect). In an ADM, for example, an STM-16 transport module is received that contains a plurality of VC-4 containers. The ADM now has the task of finding out which container is only to be forwarded and which container is to be removed from the STM-16, so-called dropping. The ADM has to evaluate the POH and pointer from each VC-4 container separately and, depending on the evaluation, forward or drop each container individually. Alarm signals are evaluated, automatic consequential actions are started and the signal quality is supervised. This requires a certain expenditure of time, which occurs at the expense of the transmission time and results in complex hardware and software implementations in the network elements. In addition, the network management has a heavy load as a result of the high number of transmission channels.

The conventional standardized methods of channel bundling known as TCM (tandem connection monitoring in accordance with ITU-T G.707 option 1, edition March 1996) have the disadvantage that network elements that transport and evaluate the bundle have to support these complex TCM functions, which results in an appreciable additional cost during operation. In existing networks, TCM can virtually not be added on, as a consequence of which no bundles can be managed either.

### SUMMARY OF THE INVENTION

The object of the invention is to simplify the transmission of transmission channels and their control by an SDH network or SONET network.

This object is achieved by a VC-Y-Xc or AU-Y-Xc transport module for SDH or SONET for forming a group of X consecutive, fixedly concatenated, virtual containers, having a PTR for the group, a POH for the group and at least X-1 individual PTR, POH and payload segments for the transparent transmission of tributary bits, wherein X is a natural number greater than 1 and Y is equal to 3 or 4 or a natural number greater than 1.

For higher-order transmission channels, for example AU-4 or AU-3, a channel bundling is carried out if said channels have the same path course for at least one section. For said section, the network management has only to manage the one bundle instead of a multiplicity of individual channels. Since the service channels of the bundle are transparently transported, any desired combinations of service channels are conceivable. Every individual service channel, such as, for example, VC-4 or VC-3, can in turn be structured in any desired way. That is to say, a VC-4 could transport, for example, 21 VC-12 and 2 VC-3 virtual channels. However, it is also possible to fill the VC-4 in an unstructured way with ATM, IP or Ethernet user load.

If the source address and target address of the service channels of the bundles are identical, the pointer processing of this circuit level can be simplified and the bandwidth utilization improved. If, for example, two digital cross-connects (DXC) are connected to the circuit level VC-12 in an SDH network by means of a VC-4-4c bundle that transports TU-12 channels as service channels, the AU-4-PTR will never change because of the system. In such cases it is possible to dispense with the pointer processing at the VC-4 circuit level. In such cases, it also fails to result in any additional benefit if the individual VC-4 POHs are evaluated or transmitted since the VC-4-4c POH of the bundle has already been evaluated. It is therefore advantageous to pack the TU-12s directly into the useful load of the VC-4-4c in such cases. That is to say no associated VC-4 POH, AU-4 pointer is transmitted. Instead of 3*63=189, 4*63=252 TU-12s can then be transparently transported. Similar remarks apply to larger VC-4-Nc bundles with N=16, 64, 256. In the case of SONET networks, similar remarks apply if the VC-3 channels have the same source and target addresses.

A multiplicity of bundling possibilities is available. 15 AU-4 channels may, for example, be mapped in a VC-4-16c transport module. The VC-4-16c is a bundle of 16 VC-4s. The c stands for the so-called contiguous concatenation, that is to say the bundling or group formation. The first VC-4 is used, inter alia, for the POH of the group. In the subsequent 15 C-4s or VC-4s, the tributary bits to be transmitted are, inter alia, transmitted. The service channels to be transported may be mutually concatenated AU-4 or AU-3, so-called virtual or contiguous concatenation, or mutually independent AU-4 or AU-3. Furthermore, 63 AU-4 channels can be mapped in a VC-4-64c transport module. In generalized terms, for example, N-1 AU-4 channels can be mapped in a VC-4-Nc, where N may be=4, 16, 64, 128, etc. Furthermore, for example, 3×N-1 AU-3 channels can be mapped in a VC-4-Nc or in a VC-3-3Nc, where n=4, 16, 64, 256, etc. In the abovementioned examples, the number N is always a power of 2; however, N may theoretically also be any natural number greater than 1. The invention is furthermore not restricted to VC-4, but may also be applied, for example, in the case of SONET VC-3 or, generally in the case of VC-M, where M is equal to a natural number greater than or equal or 2.

Advantageously, in mapping the individual channels in the fixedly concatenated VC-4-Nc virtual containers, a byte-oriented structure is used that has as few mapping changes as possible to the conventional mapping method of (N-1)×AU-4 into the associated AUG. Similar remarks apply to an advantageous mapping of AU-3 channels into VC-3-3Nc. From now on, this mapping method is termed equivalent mapping.

A VC-4-4c, for example, is structured in such a way that, when, for example, the three VC-4 virtual containers to be transported are mapped, as few byte positions as possible have to be changed with respect to the conventional mapping. The first VC-4 to be transported is mapped onto the position of the equivalent AU-4#2, the second VC-4 is mapped onto the position of the equivalent AU-4#3 and the N-1th VC-4 is mapped onto the position of the equivalent AU-4#N. Since the POH#1 of the VC-4#1, POH#2 of the VC-4#2 and the POH#3 of the VC-4#3 fall into a range defined as fixed stuff, said POH#1 . . . 3s can additionally be transported at one byte position of the equivalent AU#1. The PTRs (pointers) of the VC4#1 . . . 3 are likewise transported in free byte positions of the conventional AU#1.

The transport module according to the invention generates a bundle of transmission channels. The network management configures, monitors, etc. the transport module as a whole. There is direct access to the transport module, but no longer to the individual transmission channels. These can only be reconfigured, etc., after de-bundling. A conventional ADM connects the transport module through as a whole. However, according to the invention, a novel ADM could terminate and generate the bundle in order to drop or to interconnect, respectively, individual channels in the bundle. In the PTR there is a pointer value that indicates the start of the associated container. The phase position of the payload is thereby matched to the transmission frequency. In the case of a terminated bundle, every channel is then examined to see whether it is to be forwarded to the next network element or to be removed from the data stream. The ADM is suitable for generating new transport modules by bundling channels that are preferably to be forwarded jointly at least to the next-but-one network element. The ADM comprises suitable means for this purpose, such as a processor having suitable software, an intermediate memory, etc. Thus, a plurality of channels having different target addresses can also be bundled if they have to traverse a common subpath up to a branching point. These transmission channels are then forwarded up to the branching point by means of a transport module according to the invention and then forwarded, for example, individually.

The novel transport module reduces, in particular the operating costs for the network management. Network elements that switch the whole bundles are less expensive than network elements that also switch individual channels in the bundle. The transport module is compatible with existing SDH and SONET standards so that it can be transmitted over an existing network without difficulty.

In particular, the conventional protection methods are applied more efficiently by means of the novel transport module since, instead of many individual protection switches, only one protection switching of the bundle has to be performed and managea.

### BRIEF DESCRIPTION OF THE DRAWINGS

The invention is explained below on the basis of exemplary embodiments using figures. In the figures:

FIG. 1 shows a diagram of a bundling of 15 VC-4s,

FIG. 2 shows a diagram of a de-bundling of 15 VC-4s,

FIG. 3 shows a diagram of a bundling of 63 VC-4s,

FIG. 4 shows a diagram of a de-bundling of 63 VC-4s,

FIG. 5 shows logic diagrams of 3 of 15 VC-4s,

FIG. 6 shows logic diagrams of 3 of N-1 VC-4s,

FIG. 7a shows a logic diagram of a VC-4-16c transport module for 15×VC-4s (mapping scheme 1),

FIG. 7b shows a logic diagram of a VC-4-16c transport module for 15×VC-4s (mapping scheme 2),

FIG. 8 shows a logic diagram of VC-4-64c transport module for 63×VC-4s,

FIG. 9 shows a diagram of a bundling of 9 TU-3s,

FIG. 10 shows a diagram of a de-bundling of 9 TU-3s,

FIG. 11 shows a diagram of a bundling of 45 TU-3s,

FIG. 12 shows a diagram of a de-bundling of 45 TU-3s,

FIG. 13 shows a diagram of a bundling of 189 TU-3s,

FIG. 14 shows a diagram of a de-bundling of 189 TU-3s,

FIG. 15 shows a diagram of a bundling of 765 TU-3s,

FIG. 16 shows a diagram of a de-bundling of 765 TU-3s,

FIG. 17 shows logic diagrams of three of N*3 AU-3s,

FIG. 18 shows logic diagrams of three of N*3 TU-3s,

FIG. 19 shows a diagram of a bundling of 47 AU-3s,

FIG. 20 shows a diagram of a de-bundling of 47 AU-3s,

FIG. 21 shows a diagram of a bundling of 191 AU-3s,

FIG. 22 shows a schematic representation of a transmission system,

FIG. 23 shows a diagram of a de-bundling of 191 AU-3s,

FIG. 24 shows a schematic representation of a transmission system,

FIG. 25 shows a logic diagram of a VC-3-48c transport module for 47×VC-4s (mapping scheme 1).

### BEST MODE FOR CARRYING OUT THE INVENTION

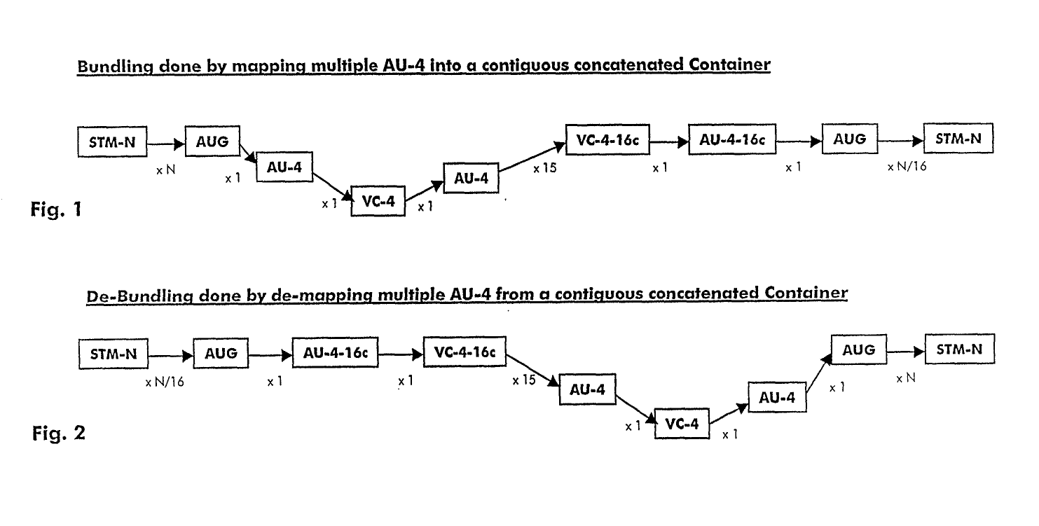

The exemplary embodiments are now explained by reference to FIGS. 1 to 25.

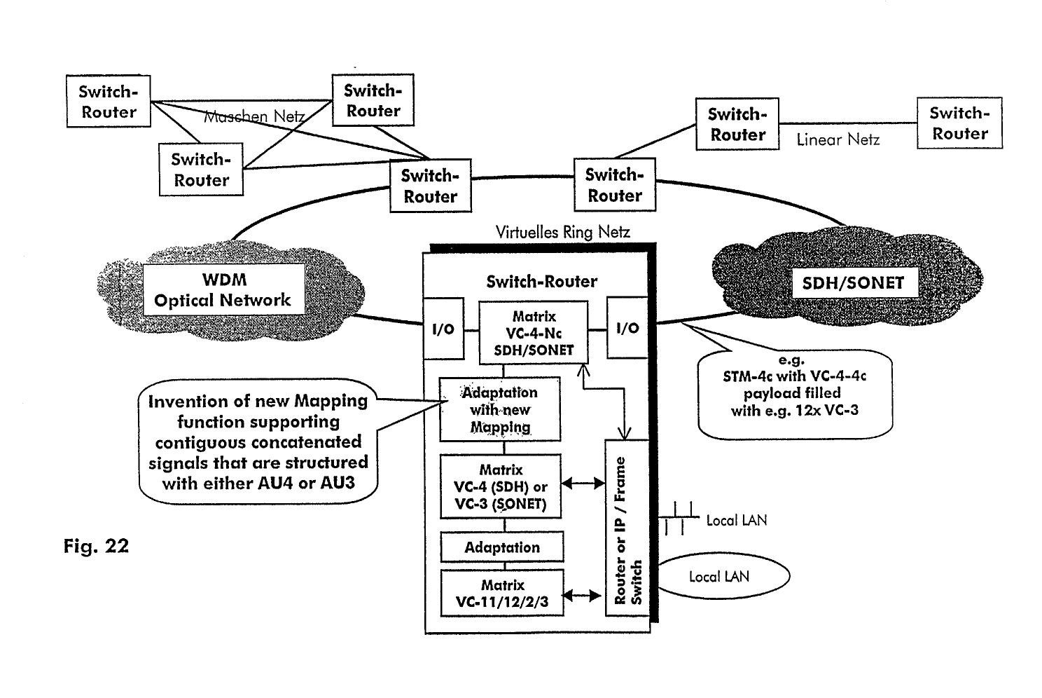

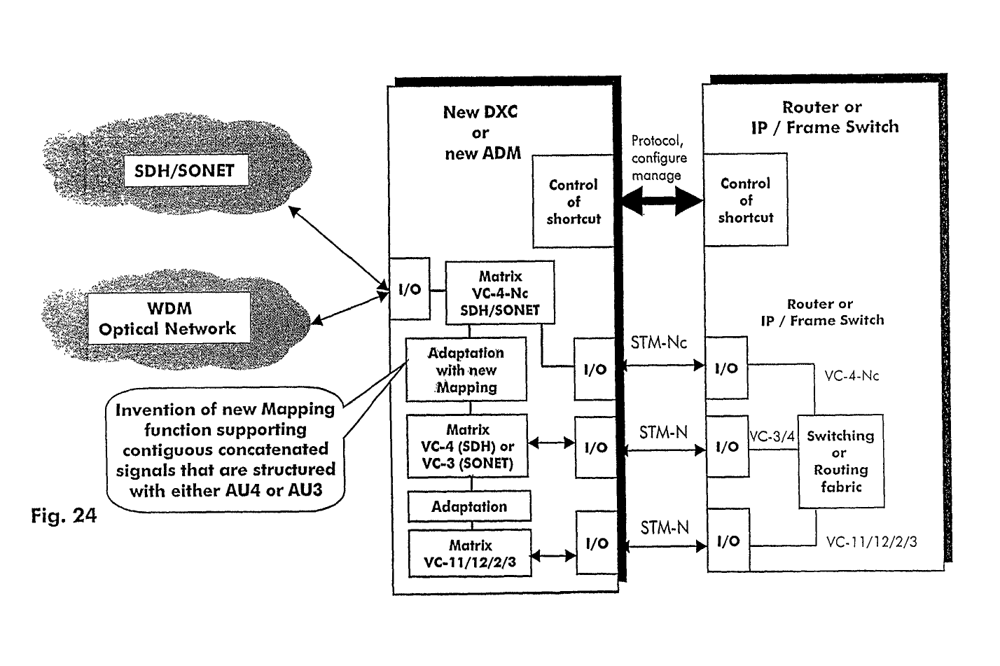

FIGS. 1 to 18 relate to SDH, FIGS. 19-21, 23 and 25 to SONET and FIGS. 22 and 24 to SDH and SONET. In the case of SDH, items of information are transmitted in so-called synchronous transport modules (STM). An STM-1 module serves, for example, to transmit 155 Mbit/s. A part of the 155 Mbit/s is the so-called overhead, in which, inter alia, synchronization signals, items of control information and so-called pointers are transmitted. A further part is the so-called payload, in which, inter alia, tributary bits are transmitted. An STM-1 frame has a byte-oriented structure containing 9 rows and 270 columns and it has a duration of 125 μs. An STM-4 module, which comprises 4 STM-1 modules, serves to transmit 622 Mbit/s. An STM-16 module, which comprises 4 STM-4 modules, serves to transmit 2288 Gbit/s. An STM-N module, which comprises N-STM-1 signals, serves to transmit N×155 Mbit/s. Equivalent to the STMs are the STSs (synchronous transport signals) in SONET. The bit rate of an STS-3 is equal, for example, to that of an STM-1, that of an STS-12 to that of an STM-4 and that of a STS-48 to that of an STM-16. The invention is not limited to SDH, but may also be applied in SONET. For the sake of simplicity, the exemplary embodiments largely relate only to SDH. There is expert procedure for finding suitably analogous applications in SONET.

Every STM-1 signal comprises an administrative unit group (AUG) that comprises in turn an administrative unit AU-4 or three administrative units AU-3. Every AU-4 comprises a virtual container VC-4 that comprises in turn a container C-4. The actual tributary bits are transmitted in the container C-4. The transmission rate for a C-4 is 149 Mbit/s.

Every AU-3 comprises a virtual container VC-3 that contains in turn either a container C-3 comprising 49 Mbit/s or seven tributary unit groups TUG-2. Every TUG-2 comprises one tributary unit TU-2, three tributary units TU-12 or four tributary units TU-11.

Every TU-2 comprises a virtual container VC-2 that contains in turn a container C-2 that serves to transmit 6 Mbit/s.

Every TU-12 comprises a virtual container VC-12 that contains in turn a container C-12 that serves to transmit 2 Mbit/s.

Every TU-11 comprises a virtual container VC-11 that contains in turn a container C-11 that serves to transmit 1.5 Mbit/s.

FIG. 1 shows a diagram of a bundling of 15 AU-4. A novel transport module VC-4-16c according to the invention is formed that comprises 15 AU-4 user signals comprising 15 VC-4s and, in addition, 230*9 bytes per frame for items of additional information, such as synchronization signals, control signals and/or data channels or other applications. The PTR of the AU-4 indicates the first byte of the VC-4. An AU-4-16c is formed by the fixedly contiguous concatenation of 16 AU-4s. Said 16 AU-4s are transmitted as a group to the next SDH network element. The VC-4-16c signal is transmitted end to end over the SDH/SONET network. No individual consideration of the individual AU-4s or VC-4 of the VC4-16c is necessary regarding the forwarding via ADMs (add-drop multiplexers) or CCs (cross-connects). The VC-4-16c group is forwarded as a whole. An STM-N comprises N AUGs that each comprise in turn an AU-4. In one STM-N, N AU-4s are consequently available. If the same intermediate or final target address is provided for 15 of the N VC-4s, said 15 VC-4s can be combined. This is done by forming the VC-4-16c into which the 15 VC-4s are mapped with the aid of an adaptation and termination function. Since the individual VC-4 virtual containers may originate from different sources having different clock sources, the conventional SDH/SONET pointer mechanism is used in order to compensate for the various clock differences. The AU-4 comprising VC-4 and PTR is therefore mapped into the VC-4-16c. It is therefore irrelevant whether the AU-4 service channels to be transported are mutually concatenated, i.e. contiguous, or whether individual, mutually independent AU-4s are involved. The transport module VC-4-16c may be transmitted, for example, in an STM-16. In FIG. 1, a corresponding AU-4-16c is formed from the VC-4-16c. An AUG that is inserted into an STM-N is formed from the AU-4-16c. N/16 VC-4-16c's can be transmitted by means of an STM-N. If, for example, N=64, 4 VC-4-16c's or 2 VC-4-16c's and 32 VC-4s or 1 VC-4-16c and 48 VC-4s can be transmitted.

FIG. 2 shows a diagram of a de-bundling of 15 VC-4s that have been transmitted by means of a VC-4-16c and an STM-N. If N=16, there is extracted from the STM-N an AUG from which an AU-4-16c is extracted from which a VC-4-16c is extracted in turn. The VC-4-16c comprises the transmitted 15 AU-4s, which are now individually available again. The start and the end, for example, of the VC-4 can be determined from the pointer position of the AU-4. The VC-4 can then be interconnected in any desired way and dropped. The VC-4-16c is broken up, for example, in an ADM at the instant at which the VC-4-16c is to be terminated since one or more VC-4s are to be interconnected. For example, the first 10 VC-4s are forwarded to a first target address and the remaining 5 VC-4s to a second target address. The 10 VC-4s may be transmitted, for example, individually to the first target address or in a new VC-4-16c, which then contains five unoccupied AU-4s. If the ADM contains further AU-4s that are likewise to be transmitted to the first target address, the unoccupied AU-4s can be filled with said AU-4s. A new VC-4-16c is always formed, for example, if at least 10 AU-4s having the same target address are present or, alternatively, only if at least 15 AU-4s having the same target address are present. If markedly more than 15 AU-4s having the same target address are present, larger VC-4-Xc's may also be formed. The X stands for the number of AU-4s, the c for the so-called contiguous concatenation, that is to say the group formation. Instead of VC-4-Xc's, VC-Y-Xc's may also be formed, where Y stands for the size of the virtual container, that is to say, for example, Y=3 in the case of SONET and Y=4 in the case of SDH ETSI. Further examples are explained below.

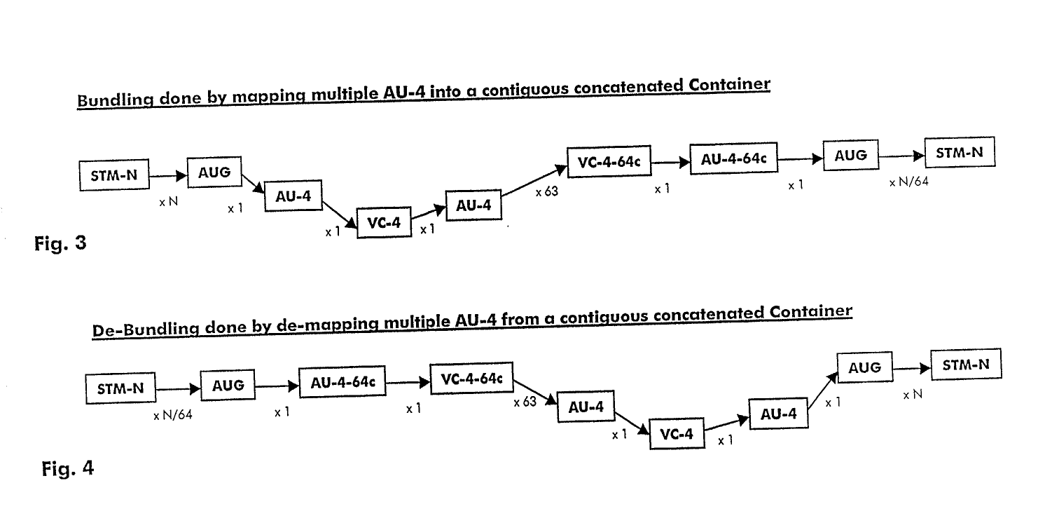

FIG. 3 shows a diagram of a bundling of 63 AU-4s or VC-4s. An STM-N contains N AU-4s. If N>63, 63 VC-4s may be connected together to form a VC-4-64c. A group of 64 fixedly contiguous, virtual containers is consequently formed that can be transmitted as a group over an SDH network. Under these circumstances, the first virtual container has a bracket function, i.e. it contains information about the start and the end of the group. It also comprises, for example, additional items of information, such as synchronization signals, control signals and/or overhead and/or items of maintenance information. The group has the same target address, with the result that it can be connected through in a simple manner in each ADM and each CC without expensive network management, in particular without individually managing and relaying the individual AU-4 in the group in every ADM or every CC.

FIG. 4 shows a diagram of a de-bundling of 63 AU-4s or VC-4s that have been transmitted in a VC-4-64c via SDH. If N=256, 2 AU-4-64c's and 127 AU-4s, for example, are extracted from the STM-N. Only the AU-4-64c is shown in FIG. 4. The AU-4-64c is converted into a VC-4-64c by evaluation and processing of the pointers and then broken up into 63 AU-4s that are processed in turn to form VC-4s. Consequently, the group is demultiplexed again and the individual VC-4s can be further transmitted from this point onwards individually or, for example, transmitted further in various groups to be newly formed.

FIG. 5 shows logic diagrams of 3 of 15 AU-4s that are to be combined in the example relating to FIG. 1 to form a group using a VC-4-16c. Every AU-4 has an AU-PTR (AU pointer), a POH (path overhead) and a payload C4, in which the tributary bits are transmitted. The numerical information relates to the quantity or the number of columns or rows, respectively.

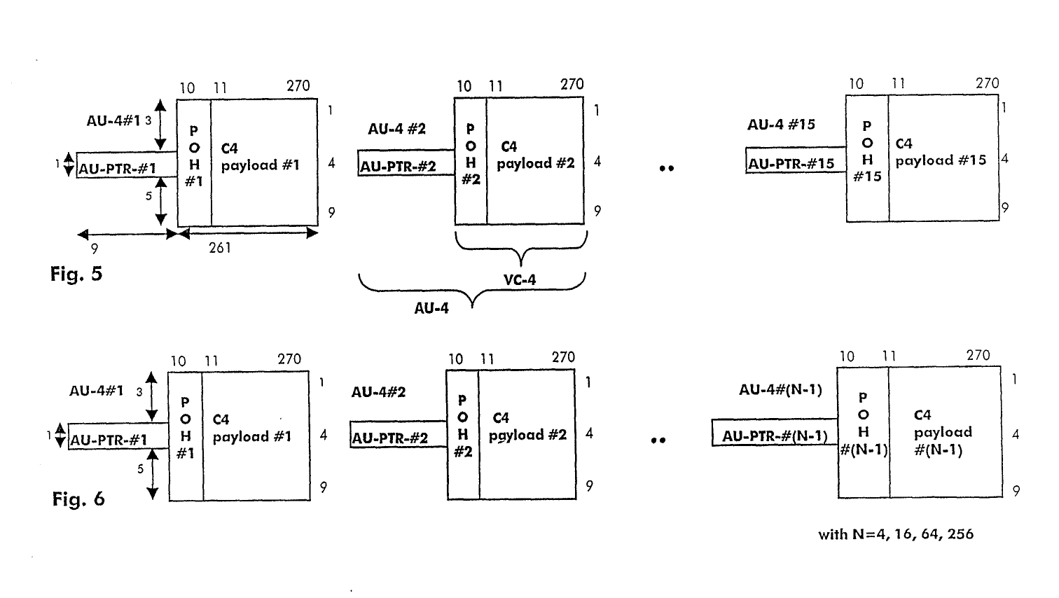

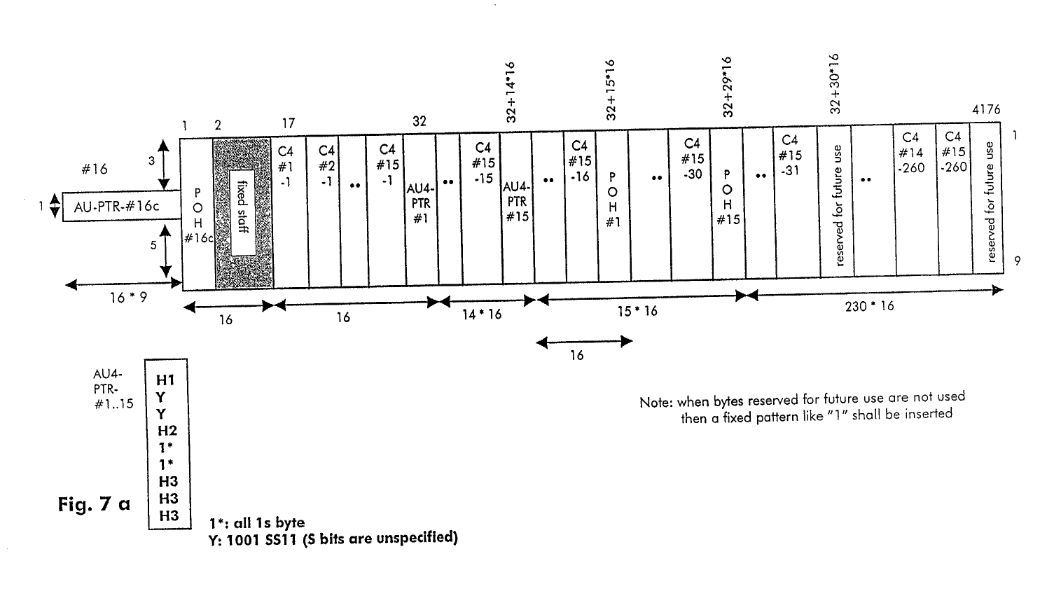

FIG. 6 shows logic diagrams of three of N-1 AU-4s. N may be, for example, 4, 16, 64 or 256. Consequently, groups of different sizes may be formed. The following transport modules, for example, are formed: VC-4-4c, VC-4-16c, VC-4-64c, VC-4-256c. To transmit 258 AU-4s to the same target address, for example, two groups are formed, one by means of the transport module VC-4-256c and the other by means of the transport module VC-4-4c. However, the 258 AU-4s can also be transmitted using 4 VC-4-64c's and 1 VC-4-16c.

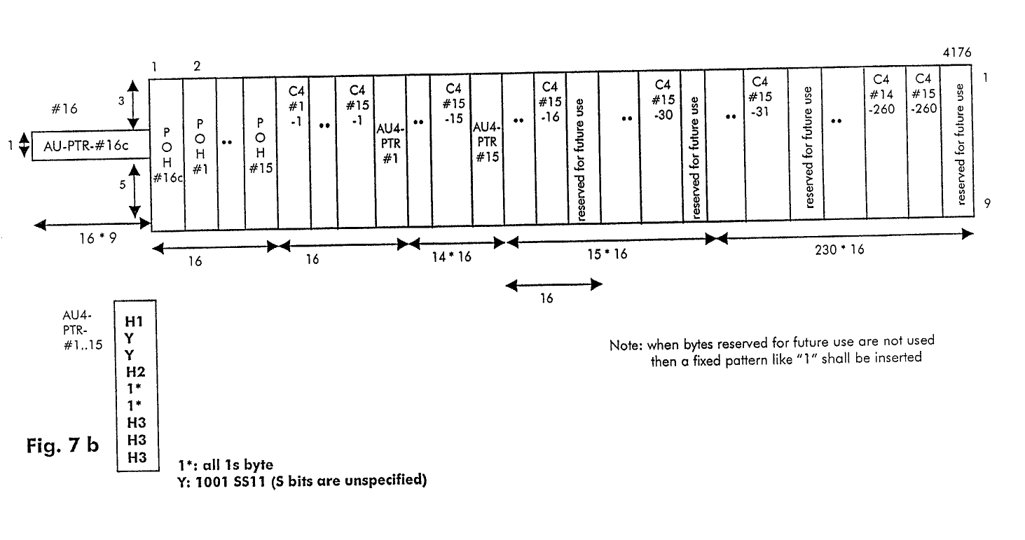

FIG. 7a shows a logic diagram of a VC-4-16c transport module according to the invention for 15×AU-4s. The numerical information relates to the quantity or the number of columns or rows, respectively. By fixedly connecting together 16 AU-4s, 16×270=4320 columns are now available; the quantity of rows remains unaltered at nine. Instead of a simple concatenation of 16 AU-4s, the 4320 columns are now re-partitioned. A new AU-PTR is inserted into the first nine*sixteen columns in the fourth row. Said AU-PTR is the pointer for the entire group. A new POH of the VC-4-16c is inserted in column 1. Said POH is the POH for the entire group. Said VC-4-16c is used to transport the 15 AU-4s shown in FIG. 5 transparently in accordance with the scheme shown in FIGS. 1 and 2. The AU-4-PTRs of the 15 AU-4s to be transported are mapped into the columns 32, 32+K*16, where K=1 . . . 14. An AU-4-PTR comprises H1, Y, Y, H2, 1*, 1*, H3, H3, H3, as shown separately. In columns 17 to 4175, the C-4 containers of the 15 AU-4s are disposed in an interconnected manner. The unutilized location, for example in the columns 32+L*16, where L=30 . . . 259, is used to transmit maintenance bytes (“bytes for future use”). The future-use bytes can be used to transmit items of maintenance information, to correct errors, etc.

In FIG. 7b, the pointers are mapped, compared with FIG. 7a, in the fixed stuff region of the VC-4-16c. This mapping has the advantage of considerable similarity to a mapping without bundling. However, it is possible that certain conventional SDH equipment may not tolerate said mapping.

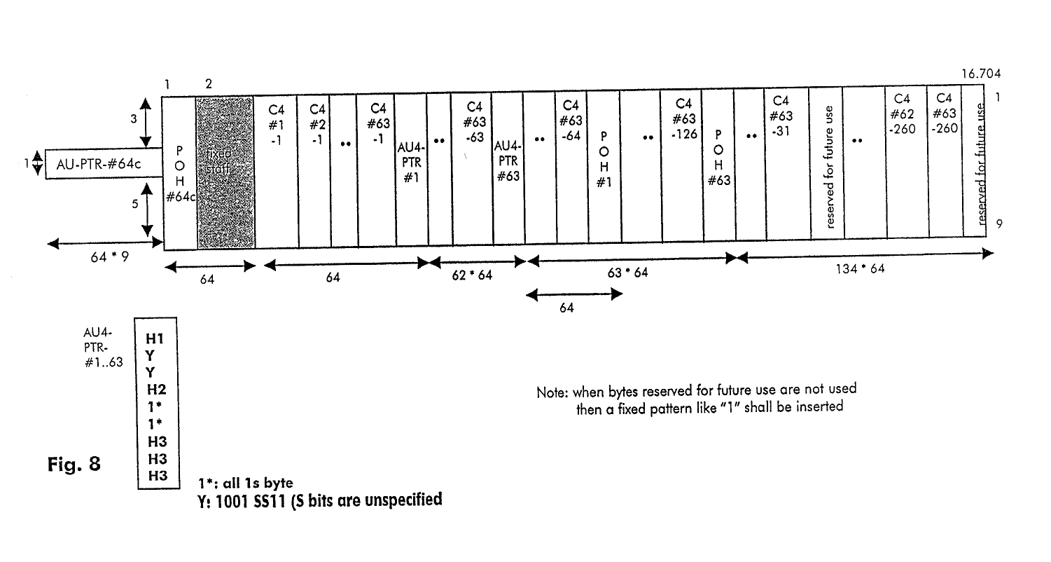

FIG. 8 shows a logic diagram of a structured VC-4-64c transport module according to the invention for the transparent transport of 63×AU-4s. The AU-4-64c comprises an AU-PTR for the group, a POH for the group and the VC-4-64c in which 63 AU-4s are transparently transported. Each of the 63 AU-4s comprises an AU-4-PTR and a VC-4 that comprises in turn a POH and an associated C-4 container. The VC-4-64c is constructed in a comparable manner to the VC-4-16c in FIGS. 7a and 7b and suitably adopted to the higher data rates to be transported.

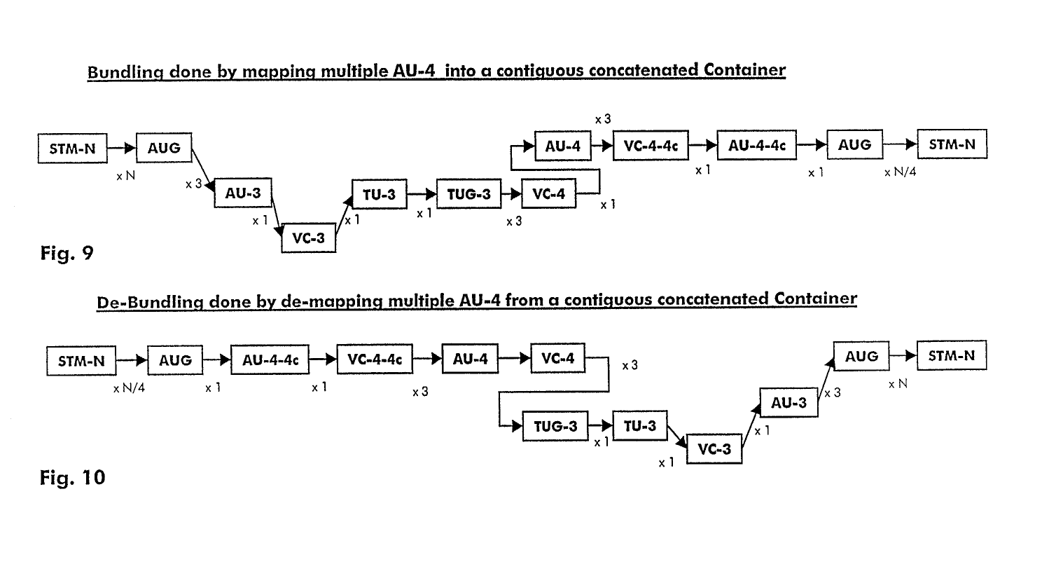

FIG. 9 shows a diagram of a bundling of 9 VC-3s or 3 AU-4s. An STM-N contains N×3 TU-3s. A VC-4 comprises 3 TUG-3s. A TUG-3 comprises one TU-3. An AU-3 can be converted into a TU-3. If, for example, N=16, 15 AU-4s are available, from which 48 TUG-3s can be formed. A VC-4-4c may transport three AU-4s or 9 TU-3s transparently. A group is consequently formed from three AU-4s.

FIG. 10 shows a diagram of a de-bundling of 9 VC-3s. A de-bundling, i.e. a demultiplexing of the group(s), can be carried out that corresponds to the bundling in FIG. 9. The individual VC-3 virtual containers can then be transmitted further via SDH equipment individually or in new groups.

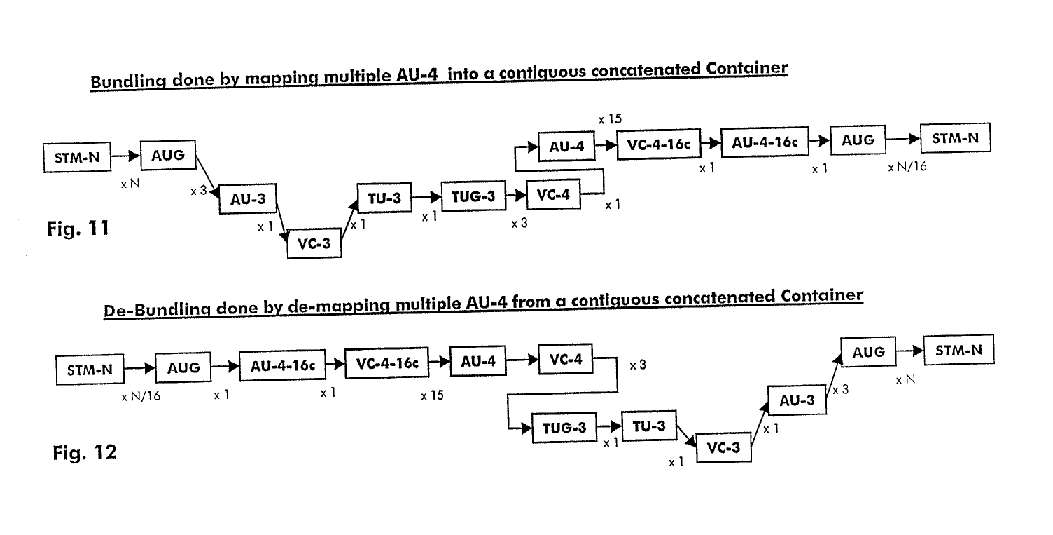

FIG. 11 shows a diagram of a bundling of 45 VC-3s. A VC-4 contains 3 TUG-3s. Consequently, 45 TUG-3s can be transmitted in a VC-4-16c. The formation of the group takes place comparatively to FIG. 9.

FIG. 12 shows a diagram of a de-bundling of 45 VC-3s. A de-bundling, i.e. a demultiplexing of the group(s), can be carried out that corresponds to the bundling in FIG. 11. The individual VC-3s can then be transmitted further via SDH equipment individually or in new groups.

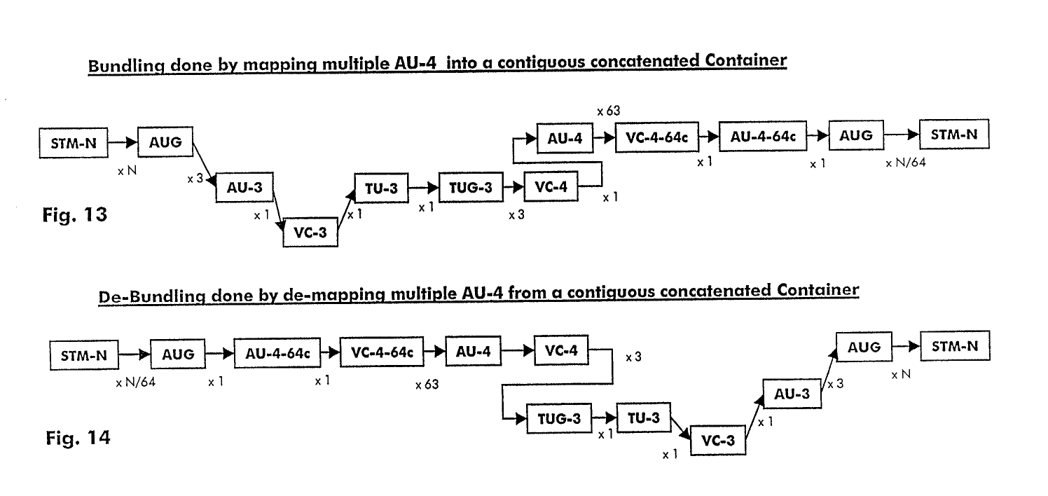

FIG. 13 shows a diagram of a bundling of 189 VC-3s. A VC-4 contains 3 TUG3s. In a VC-4-64c, 189 TUG-3s can consequently be transmitted. The formation of the groups takes place in a comparable manner to FIG. 9.

FIG. 14 shows a diagram of a de-bundling of 189 VC-3s. A de-bundling, i.e. a demultiplexing of the group(s), can be carried out that corresponds to the bundling in FIG. 13. The individual VC-3 containers can then be transmitted further via SDH equipment individually or in new groups.

FIG. 15 shows a diagram of a bundling of 765 VC-3s. A VC-4 contains 3 TUG3s. In a VC-4-256c, 765 TUG-3s can consequently be transmitted. 767 TUG-3s serve to transmit items of information, while a TUG-3 serves as bracket for the group. The formation of the group takes place in a comparable manner to FIG. 9.

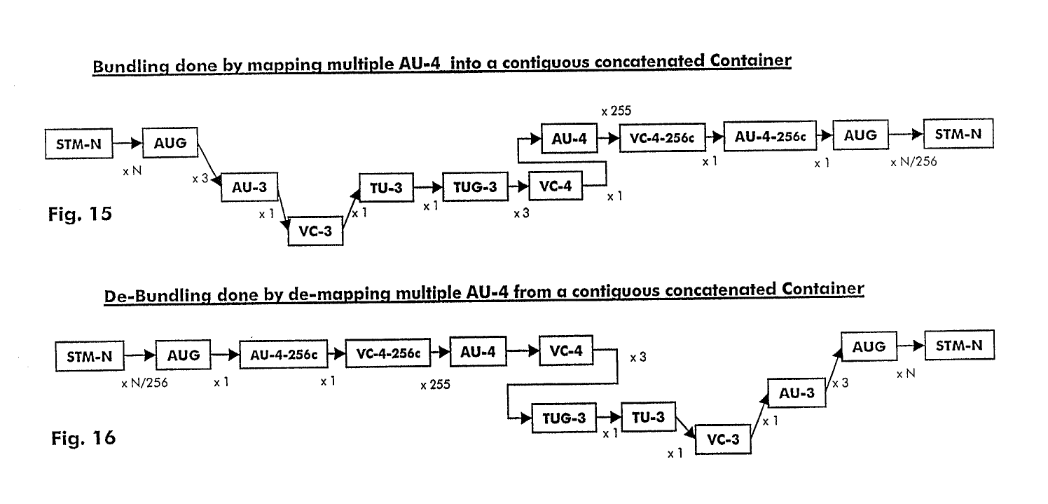

FIG. 16 shows a diagram of a de-bundling of 765 VC-3s. A de-bundling, i.e. a demultiplexing of the group(s), can be carried out that corresponds to the bundling in FIG. 15. The individual VC-3 containers can then be transmitted further via SDH equipment individually or in new groups.

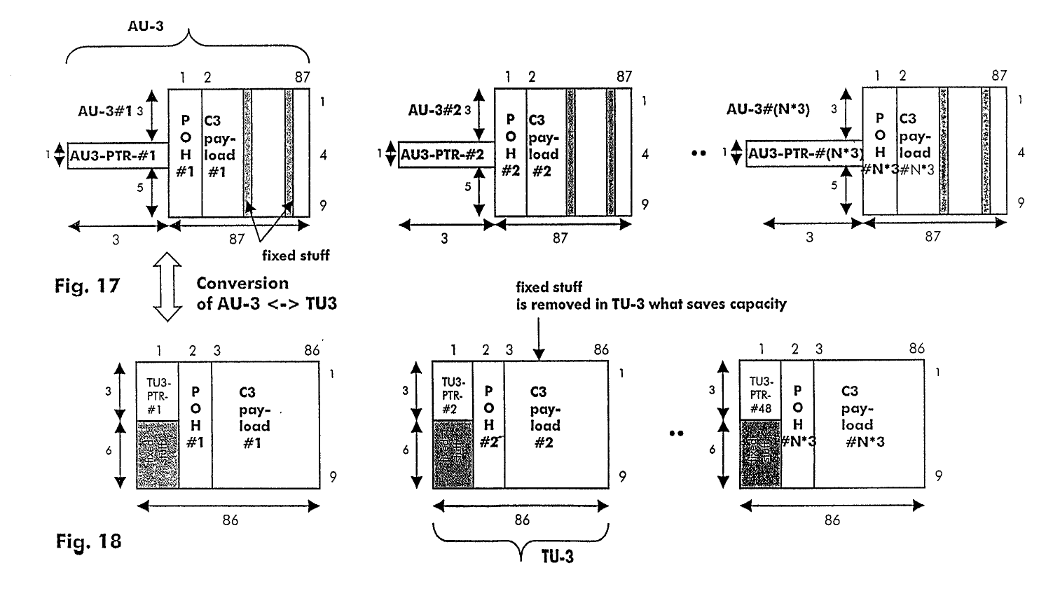

FIG. 17 shows logic diagrams of 3 of N×3 AU-3s that are extracted, for example, from an STM-N. Each AU-3 has a pointer, the AU-PTR, a path overhead, the POH, and a C3 payload, i.e. a C3 container, in which the user information is transmitted.

FIG. 18 shows logic diagrams of 3 of N*3 TU-3s that are extracted, for example, from an STM-N. Each TU-3 has a pointer, the TU-3-PTR, a path overhead, the POH, and a C3 payload, i.e. a C3 container, in which the user information is transmitted.

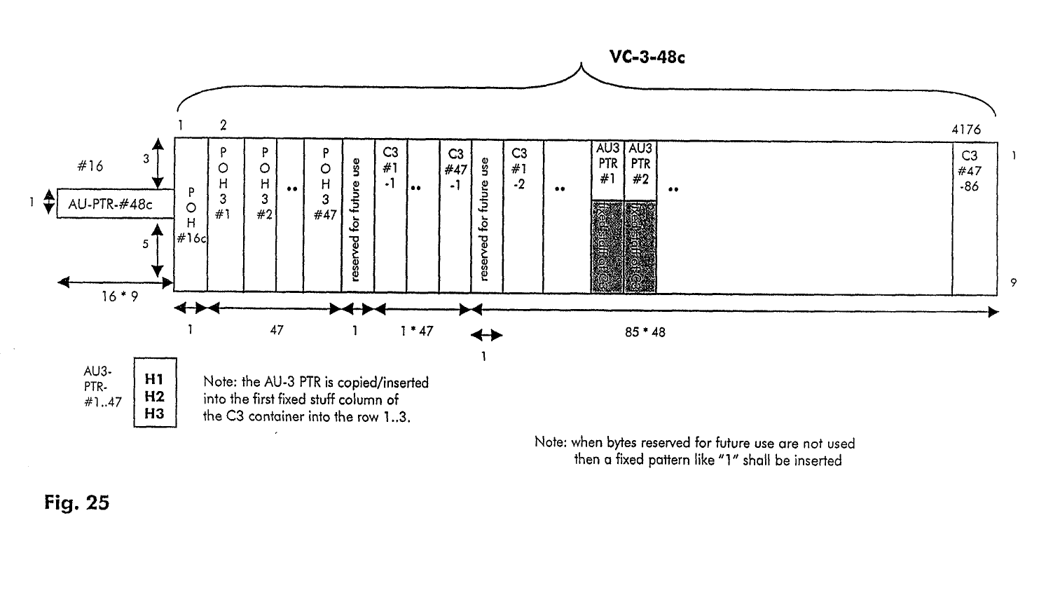

FIG. 19 shows a logic diagram of a VC-3-48c according to the invention that is particularly suitable for transmitting 47 VC-3s in SONET networks. In SONET networks, the VC-3 is transported in an AU-3, for which reason this mapping is used here. A VC-3-48c corresponds to a VC-4-16c shown in FIGS. 7a and 7b, respectively. In a VC-3-48c, 260*16*9+15*9 bytes can be used per frame for the transport of AU-3 shown in FIG. 17. So that as many AU-3 useful signals as possible can be transported in a VC-3-48c, it is conceivable to remove the two fixed stuff rows of the VC-3 of the AU-3. If, however, as similar a mapping as possible of the AU-3 to that in the case of conventional transport modules is desired, the mapping shown in FIG. 25 is particularly advantageous. Only the AU-3 pointer is transported at another position, mainly in a conventional fixed stuff region of the VC-3. Of course, it would also be conceivable to transport the AU-3 pointer in the region “reserved for future use”.

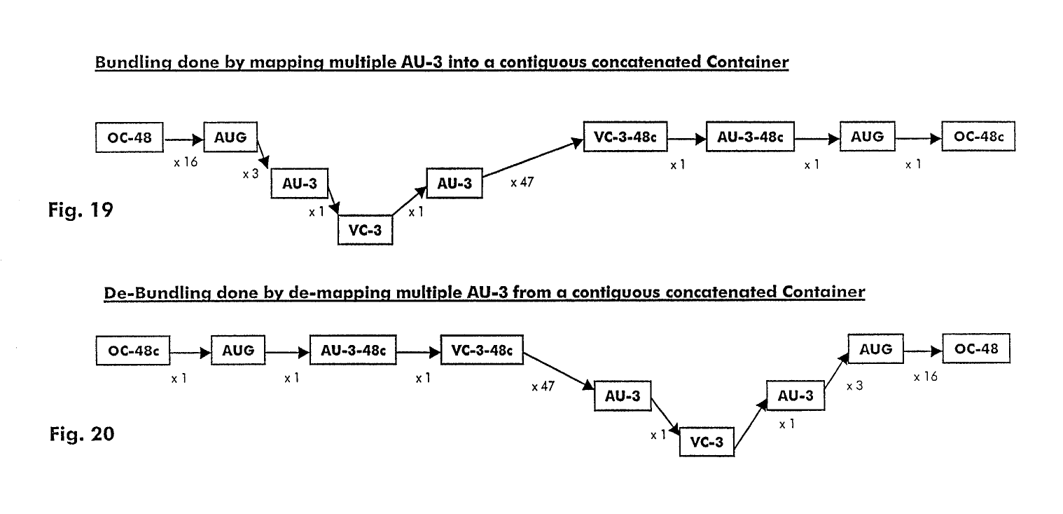

FIG. 20 shows a logic diagram of a VC-3-48c transport module according to the invention for the transparent transport of 47 VC-3s or AU-3s. The demapping is shown in a manner comparable to the VC-3-48c in FIG. 19. Advantageously, an AU-3 is mapped directly into the payload (VC-3-48c) in a SONET network. In order to use up as little bandwidth as possible, it is even possible to remove the fixed stuff rows of the VC-3. In the exemplary embodiment shown in FIG. 24, the fixed stuff rows were not removed. It is, however, also possible to remove them. With this mapping scheme, up to 47 AU-3s can be transported transparently and these each contain in turn a VC-3 that can be structured or restructured as desired.

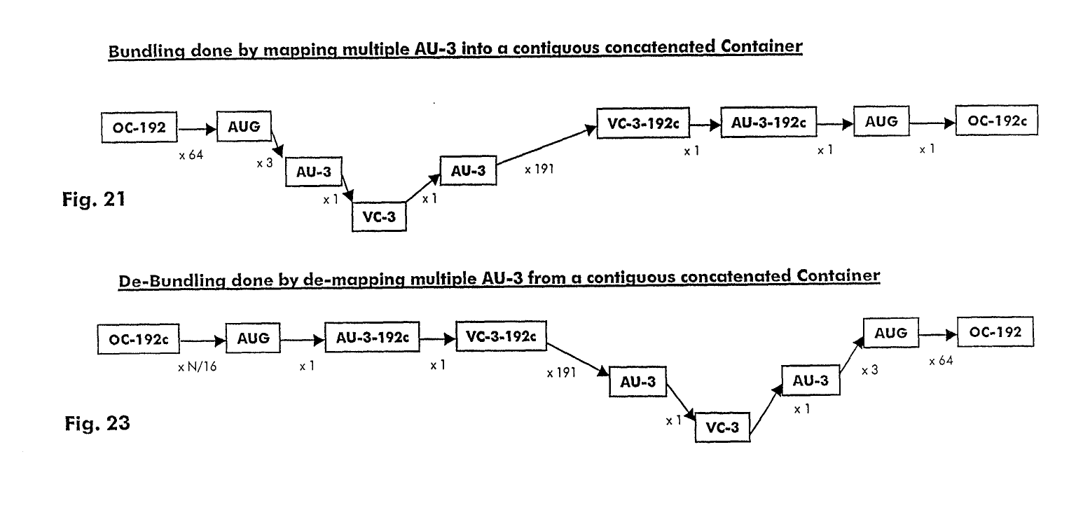

FIG. 21 shows a logic diagram of a VC-3-192c transport module according to the invention for 191×AU-3s. In a comparable manner to the VC-3-48c in FIG. 19, 191 AU-3s are transmitted in a VC-3-192c.

FIG. 23 shows a logic diagram of a VC-3-192c transport module according to the invention for 191×AU-3s. In a manner comparable to the VC-3-48c in FIG. 21, 191 AU-3s are transmitted in a VC-3-192c. How the VC-3s are unpacked from a VC-3-192c if the AU-3s have been mapped directly into the VC3-192c is shown.

FIG. 22 shows a schematic representation of a transmission system. The transmission network comprises an SDH or SONET network and a WDM/optical network and switch routers according to the invention. The switch routers may be disposed in a mesh topology, linear topology or ring topology. The switch routers are interconnected via signal routes or paths that can transport the structured VC4-Nc or VC-3-Nc signals according to the invention, where, for example, N=X. The switch routers may be interconnected via mesh, ring or linear networks. A switch router is disposed in every path. Every switch router comprises input/output interfaces I/O to the networks and also a VC-4-Nc matrix, a VC-3 or VC-4 matrix and, optionally, a VC-11/12/2/3 matrix and a router or an IP/frame switch. In the SDH case, the matrices serve to filter out of the received data stream of the one SDH network those VCs that are to be forwarded to the other SDH network and those that are to be forwarded to the router or IP/frame switch. The switch router therefore has the function of an ADM and, in addition, a router function through the router. A VC-4-4c transport module is received in the matrix. If the target address of the bundle agrees with the switch router, the group is broken up, i.e. the individual group members, for example 3 VC-3s, are identified. Six of the 9 VC-3s are, for example, intended for forwarding to the next SDH network. The forwarding may take place, for example, in 6 single TU-3s or in the form of a group to be regenerated, for example by inserting further TU-3s that have the same target address and are made available by the router. Three of the 9 VC-3s are, for example, intended for forwarding to the router. These are fed to the router, which forwards them accordingly, for example to a further transmission network, for example a LAN (local area network) or a WAN (wide area network). If the entire group is intended for forwarding to the next SDH network, the matrix recognizes this from the network management information and forwards the entire group, for example the VC-4-4c, accordingly, without taking the content of the group into account. Since only a fraction of the network traffic is switched to the router, it is accordingly possible to scale every individual matrix optimally. That is to say, in the case of typical network applications, only about 20-50% of the traffic is interconnected into the next smaller matrix stage, and for this reason, the VC-4-Nc matrix has, in a particularly economical version, the greatest switching capacity, calculated in STM-1 equivalents. On the other hand, the VC-4 matrix has much smaller dimensions. Since the matrices having a smaller switching granularity are more expensive than those having a larger one, the switch router according to the invention is particularly inexpensive.

The function of the switch router can also be provided by combining an ADM or CC with a router. This is shown in FIG. 24.

With the switch router according to the invention it is possible to perform so-called shortcuts efficiently. A shortcut connects two routers, an attempt being made to switch the signals or the channels through as few SDH matrices as possible. Furthermore, it is particularly advantageous to switch with as great granularity as possible in the matrix. To control the SDH/SONET matrices, the items of information and protocols of the router can be used that can calculate the traffic statistics. For this purpose, for example, the standarized MPLS (multiprotocol label switching) protocol could be used.

FIG. 25 shows the precise byte mapping of a VC-3-48c according to the invention with a payload of 47×AU-3s. In a comparable manner to the VC-3-16c in FIGS. 7a or b, 47 AU-3s are transmitted in a VC-3-48c.

1. VC-Y-Xc or AU-Y-Xc transport module for SDH or SONET for forming a group of X consecutive, fixedly concatenated, virtual containers, having a PTR for the group, a POH for the group and at least X-1 individual PTR, POH and payload segments for the transparent transmission of tributary bits, wherein X is a natural number greater than 1 and Y is equal to 3 or 4 or a natural number greater than 1.

2. VC-Y-Xc transport module according to claim 1, the transport module comprising an AU-PTR and a VC-Y-Xc-POH for the group, and also comprises, according to the number of service channels to be transmitted with the group, correspondingly AU-3 or AU-4 PTR, POH and container.

3. VC-Y-Xc transport module according to claim 1, wherein Y=4 and X=4 and wherein the transport module serves to transmit 3 AU-4s or 9 TU-3s.

4. VC-Y-Xc transport module according to claim 1, wherein Y=4 and X=16 and wherein the transport module serves to transmit 15 AU-4s or 45 TU-3s.

5. VC-Y-Xc transport module according to claim 1, wherein Y=4 and X=64 and wherein the transport module serves to transmit 63 AU-4s or 189 TU-3s.

6. VC-Y-Xc transport module according to claim 1, wherein Y=4 and X=256 and wherein the transport module serves to transmit 255 AU-4s or 765 TU-3s.

7. VC-Y-Xc transport module according to claim 1, wherein Y=3 and X=N, where N=12, 48, 192 or 768, and wherein the transport module serves to transmit N-1 AU-3s.

8. VC-Y-Xc transport module according to claim 1, wherein Y=4 and X=N, where N=16, 64 or 256, and wherein the transport module serves to transmit at least (N/Z)-1 AU-4-Zc's, where Z=4, 16 or 64.

9. VC-Y-Xc transport module according to claim 1, wherein Y=3 and X=N, where N=48, 192 or 768, and wherein the transport module serves to transmit at least (N/Z)-1 AU-3-Zc's, where Z=3, 12, 48 or 192.

10. VC-Y-Xc transport module according to claim 1, wherein the multiplex structure used in the VC-Y-Xc is signalled in the so-called C2 byte of the POH of the group, and wherein this signals a pure AU-4 or AU-3 or mixed AU-4 and AU-3 payload.

11. Device for bundling transmission channels in SDH or SONET that is suitable for generating a transport module according to claim 1.

12. Device for de-bundling transmission channels in SDH or SONET that is suitable for breaking up a transport module according to claim 1.

13. Switch router for SDH or SONET, comprising a first matrix for VC-Y-Xc and a second matrix for VC-4 or VC-3, an adaptation module that is connected between the first and the second matrix and a router or an IP, ATM or frame switch that is connected to the first and second matrix, wherein the adaptation module is suitable for breaking up a transport module according to claim 1 and/or for generating one.

14. Network element of an SDH or SONET network, comprising a first matrix for VC-Y-Xc, a second matrix for VC-4 or VC-3 and an adaptation module that is connected between the first and the second matrix and that is suitable for breaking up a transport module according to claim 1 and for generating one.

15. Network element according to claim 10, comprising an add-drop multiplexer function or a cross-connect function.

16. Method of transmitting virtual containers of SDH or SONET signals in which a group of AU-3s or AU-4s is transmitted in a transport module according to claim 1 with an AU-PTR and an AU-POH for the group.

17. VC-Y-Xc transport module according to claim 1, the payload segments being comprised in the bundle comprising service channels to be transparently transmitted comprise a mixture of AU-4s and AU-3s.

18. VC-Y-Xc transport module according to claim 1, the payload segments in the bundle comprising service channels to be transparently transmitted that have different target addresses and/or different source addresses, and the pointers of the virtual service channels being therefore transmitted concomitantly to compensate for frequency deviations.

19. VC-Y-Xc transport module according to claim 1, the payload segments in the bundle comprising service channels to be transparently transmitted that all have the same target addresses and source addresses, wherein the TU-3s or TU-2s or TU-12s or TU-11s to be transmitted are mapped directly into the VC-Y-Xc without intermediate circuit levels VC-4 und AU-4.

20. VC-Y-Xc transport module according to claim 1, the payload segments in the bundle comprising service channels to be transparently transmitted that all have the same target addresses and source addresses, wherein the TU-2s or TU-12s or TU-11s to be transmitted are mapped directly into the VC-Y-Xc without an intermediate circuit level VC-3 and AU-3.
